(19) United States
(12) Patent Application Publication
(10) Pub. No.: US 2026/0229885 A1
(43) Pub. Date: Aug. 6, 2026

(54) POWER SHARING IN AN AIRCRAFT USING CENTRALIZED CONTROL

(71) Applicants: SAFRAN, Paris (FR); SAFRAN ELECTRICAL & POWER, Blagnac (FR)

(72) Inventors: Florent Jean-Arnaud ROUGIER, Moissy-Cramayel (FR); Geoffrey BEGGIORA, Moissy-Cramayel (FR); Guillaume Francois Daniel BIDAN, Moissy-Cramayel (FR); Anne Marie LIENHARDT, Moissy-Cramayel (FR)

(21) Appl. No.: 19/150,857

(22) PCT Filed: Feb. 2, 2024
(86) PCT No.: PCT/FR2024/050138

§ 371 Date: Jul. 24, 2025

(30) Foreign Application Priority Data
Feb. 3, 2023 (FR) 2301036

(51) Int. Cl. H02J 1/102; B64D 31/18

(52) U.S. Cl. CPC H02J 1/102; B64D 31/18; B64D 2221/00

(57) ABSTRACT

A system for exchanging power in an aircraft, the system including a voltage bus; a low-pressure electromechanical converter; a high-pressure electromechanical converter; and for each electromechanical converter a voltage control module and a control module for ensuring that the exchange setpoint is observed. The system further includes a power adjustment module configured, for at least one of the electromechanical converters: to determine a voltage correction; and to apply, in the voltage control module associated with the relevant electromechanical converter, the voltage correction to a voltage setpoint so that the voltage control module adjusts the bus voltage to the corrected voltage setpoint.

### TECHNICAL FIELD OF THE INVENTION

The present invention relates to a power exchange installation in an aircraft, a propulsion system of an aircraft comprising such an installation, an aircraft comprising such a propulsion system, as well as a corresponding method.

### TECHNICAL BACKGROUND

In a context of reducing the ecological footprint of the aircrafts, hybrid electric power appears to be a technological solution that may significantly improve the environmental performance of the aircrafts, in particular by reducing their fuel consumption.

It is known in the prior art that power exchange installations in an aircraft comprise:
a voltage bus designed to have a bus voltage;
a low-pressure (BP) electromechanical converter designed to exchange power between the voltage bus and a low-pressure body of a turbomachine of the aircraft;
a high-pressure (HP) electromechanical converter designed to exchange power between the voltage bus and a high-pressure body of the turbomachine of the aircraft; and
for each electromechanical converter:
   a voltage control module, designed to control the bus voltage by determining an exchange setpoint for the electromechanical converter in question, and
   a module for controlling the electromechanical converter in question, designed to control the electromechanical converter in question so that the electromechanical converter in question complies with the exchange setpoint.

The voltage bus is generally part of an electrical network of the aircraft, this electrical network may also comprise sources and/or loads connected to the voltage bus.

In this way, the electromechanical converters form an interface between the HP and BP bodies of the turbomachine and the electrical network of the aircraft.

To ensure the correct operation of the loads in particular, the bus voltage must remain within a predefined range, which is made possible by the bus voltage control modules respectively associated with the electromechanical converters.

These control modules may have a zero static bus voltage error, which has the advantage that the bus voltage remains very close to its setpoint. However, these two controls of the bus voltage are independent of each other and may compete with each other, leading to a drift in power sharing, with one electromechanical converter exchanging all the power and the other none at all.

One of the solutions to this problem proposed in the prior art is a so-called “decentralized” installation implementing a droop control to define the power split between the power exchanged by the low-pressure body and the power exchanged by the high-pressure body, by defining appropriate droop coefficients. However, the bus voltage control modules then have a non-zero static error, so that the bus voltage remains far from its setpoint, which may lead it to go out of range when power is called up by a load on the electrical network or when power is supplied by a source.

In addition, the control of the power sharing is highly dependent on the accuracy of the bus voltage measurement and requires a highly accurate acquisition chain (<1% error).

Alternatively, one of the two electromechanical systems should control the bus voltage and the other system should apply a power draw or power input setpoint coming from the central computer.

However, this solution has the disadvantage of not being robust to the loss of the electromechanical system controlling the bus voltage. The other system may reconfigure itself, but there will be a loss of network over a long period of time, electrically speaking. In addition, the central computer must constantly send a setpoint to the system not performing the voltage control.

Another solution in the prior art is to propose a so-called “centralized” installation, where an external computer performs the control of the bus voltage, applies or does not apply a power draw or power input setpoint from the central computer and distributes the power or torque setpoints to the two electromechanical converters.

This system has the advantage of being robust to the loss of one of the two electromechanical converters. The two electromechanical converters may then control the voltage and share the power to be drawn.

However, the dependency between the centralized computer and the two electromechanical converters requires the addition of a fast communication (greater than 10 kHz).

Furthermore, the Japanese patent application published under the number JP 2014 131469 A describes two generators coupled to a turbomachine, and two controllers for respectively controlling these two generators. Each controller is designed to receive a power ratio setpoint and the ratio of the current supplied by the associated generator with respect to the total current supplied by the two generators. This ratio is calculated from measurements of the current supplied by each of the generators. Each controller is designed to supply, to the associated generator, a voltage setpoint that the generator must supply, calculated by the value of a resistance calibrated in an output filter, which requires an accurate knowledge of this resistance value, difficult to obtain due in particular to variations in the environment (temperature, etc.). The U.S. Pat. No. 11,355,929 is substantially similar, except that it does not describe the precise operation of the controllers and that the current ratio is calculated from measurements of the current supplied by the associated generator and measurements of the total current supplied by the two generators.

It may therefore be desirable to provide a system that avoids at least some of the problems and constraints mentioned above.

### SUMMARY OF THE INVENTION

It is therefore proposed an installation for exchanging power in an aircraft, comprising:
a voltage bus designed to present a bus voltage;
a low-pressure electromechanical converter designed to exchange power between the voltage bus and a low-pressure body of a turbomachine of the aircraft;
a high-pressure electromechanical converter designed to exchange power between the voltage bus and a high-pressure body of the turbomachine of the aircraft; and
for each electromechanical converter:
   a voltage control module, designed to control the bus voltage by determining an exchange setpoint for the electromechanical converter in question, and
   a control module designed to control the electromechanical converter in question, so that the electromechanical converter in question complies with the exchange setpoint;
characterized in that it further comprises a power adjustment module designed, for at least one of the electromechanical converters, for:
determining a voltage correction; and
applying, in the voltage control module associated with the electromechanical converter in question, the voltage correction to a voltage setpoint so that the voltage control module controls the bus voltage to the corrected voltage setpoint.

Thus, thanks to the invention, it is possible, on the one hand, to implement a decentralized voltage control, i.e. duplicated on the two electromechanical converters. This ensures a robustness in the event of the loss or failure of the control on one side. In addition, the power exchanged by each of the electromechanical converters may be controlled centrally. This allows to avoid any drift in power sharing (which may result in power being supplied by only one side) and also allows the power or powers exchanged to be defined according to the needs of the turbomachine.

In addition, by using a voltage correction applied in the voltage control module, a frequency of updating the voltage correction may be kept low, which avoids the need for rapid communication.

In addition, applying a correction to a voltage setpoint means that if the power adjustment module fails so that it no longer provides a correction (equivalent to zero correction), the DC voltage control module automatically continues to operate by controlling the voltage at the voltage setpoint. This prevents the fault from spreading.

A power exchange installation according to the invention may also comprise one or more of the following optional characteristics, in any technically possible combination.

Optionally, the exchange setpoint is a power setpoint to be exchanged between the electromechanical converter in question and the voltage bus.

Also optionally, the exchange setpoint is a setpoint for a current to be exchanged between the electromechanical converter in question and the voltage bus or, alternatively, the electromechanical converters each comprising an electric machine coupled to the associated body, the exchange setpoint is a torque setpoint for the electric machine.

Optionally, the power adjustment module of the turbomachine also comprises:
a variation calculation module designed to determine a power correction to be exchanged by the electromechanical converter in question; and
a corrector designed to determine the voltage correction from the power correction to be exchanged.

Optionally, the corrector has a zero static error.

Also optionally, the voltage correction is determined in order to control an operating characteristic of the turbomachine to a setpoint.

Optionally, the voltage correction is determined from a measurement of the operating characteristic and of the setpoint of the operating characteristic.

Also optionally, the power adjustment module furthermore comprises a setpoint determination module designed to determine a so-called direct exchange setpoint, and the installation furthermore comprises, for the electromechanical converter in question, a selection module designed to, on command, receive the direct exchange setpoint and supply the latter to the control module of the electromechanical converter in question, instead of the exchange setpoint supplied by the voltage control module, so that the electromechanical converter in question complies with the direct exchange setpoint.

Optionally, the installation also comprises local computers, respectively low pressure and high pressure, independent of each other, and respectively coupled to the low pressure and high pressure electromechanical converters, each local computer implementing at least the control modules for controlling the voltage of the bus voltage and for controlling the electromechanical converter in question.

Optionally, the installation also comprises a central computer implementing at least the power adjustment module.

Optionally, the central computer is also independent of the local computers.

Also optionally, the voltage control module is designed to implement the voltage control at a voltage control frequency, and the power adjustment module is designed to update the voltage correction at a frequency lower than the control frequency, preferably at a frequency ten times lower.

A propulsion system for an aircraft comprising a turbomachine and an installation according to the invention is also proposed.

An aircraft comprising a propulsion system according to the invention is also proposed.

A method for exchanging power in an aircraft is also proposed, characterized in that it comprises:
for each of a so-called low-pressure electromechanical converter and a so-called high-pressure electromechanical converter, the low-pressure electromechanical converter being designed to exchange power between a voltage bus designed to have a bus voltage and a low-pressure body of a turbomachine of the aircraft, the high-pressure electromechanical converter being designed to exchange power between the voltage bus and a high-pressure body of the turbomachine of the aircraft:
   controlling the bus voltage by determining an exchange setpoint for the electromechanical converter in question, and
   controlling the electromechanical converter in question, so that the electromechanical converter in question complies with the exchange setpoint; and
for at least one of the electromechanical converters:
   determining a voltage correction, and
   applying the voltage correction to a voltage setpoint so that the bus voltage is controlled at the corrected voltage setpoint.

Also provided is a computer program downloadable from a communication network and/or recorded on a computer-readable medium, characterized in that it comprises instructions for executing the steps of a method for exchanging power in an aircraft according to the invention, when said program is executed on a computer.

### BRIEF DESCRIPTION OF THE FIGURES

The invention will be better understood with the aid of the following description, given only by way of example and made with reference to the attached drawings wherein:

FIG. 1 is a simplified view of a power exchange installation according to the invention in an aircraft,

FIG. 2 is a functional view of the bus voltage control module of the high-pressure converter coupled to a control module of said converter, to provide the power setpoint,

FIG. 3 is a functional view of the bus voltage control module of the low-pressure converter coupled to a control module of said converter, to provide the power setpoint.

FIG. 4 is a functional view of the control module of the high-pressure converter, for controlling the power exchanged by said converter to the power setpoint supplied by the voltage controller of said converter,

FIG. 5 is a functional view of the control module of the low-pressure converter, for controlling the power exchanged by said converter to the power setpoint supplied by the voltage controller of said converter,

FIG. 6 is a simplified view of the installation according to the invention, with selection modules for direct application of power setpoints to be shared, and

FIG. 7 is a functional view of a power exchange method in an aircraft.

### DETAILED DESCRIPTION OF THE INVENTION

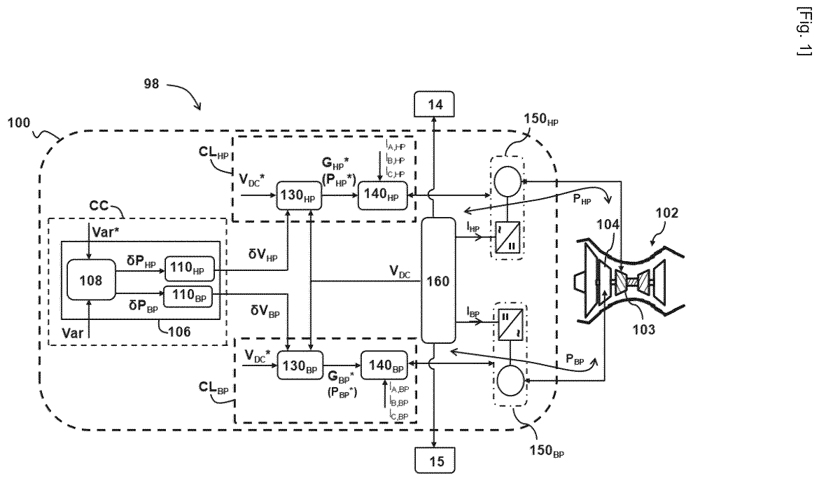

With reference to FIG. 1, an example of a propulsion system 98 of an aircraft, wherein the invention is implemented, will now be described.

The propulsion system 98 firstly comprises a turbomachine 102 comprising a low-pressure body 104 and a high-pressure body 103. The turbomachine 102 is, for example, a propulsion turbomachine of the aircraft.

The propulsion system 98 also comprises a power exchange installation 100.

The installation 100 comprises a voltage bus 160 and, for example, at least one electrical load 14, 15 connected to the voltage bus 160. Each load 14, 15 corresponds, for example, and without limitation, to one or more items of equipment of the aircraft. In operation, the voltage bus 160 has a continuous bus voltage V_{DC}.

The installation 100 also comprises an electromechanical converter 150_{BP}, referred to as a low-pressure converter, designed to exchange power P_{BP} between the voltage bus 160 and the low-pressure body 104. The low-pressure electromechanical converter 150_{BP} is thus designed, for example, in a first power transfer direction, to draw mechanical power from the low-pressure body 104 so as to supply electrical power to the voltage bus 160. The low-pressure electromechanical converter 150_{BP} is also designed, for example, in a second power transfer direction, to draw electrical power from the voltage bus 160 so as to supply mechanical power to the low-pressure body 104. To exchange the power P_{BP}, a current I_{BP} is exchanged between the voltage bus 160 and the low-pressure electromechanical converter 150_{BP}.

Similarly, for the high-pressure body 103, the installation 100 also comprises an electromechanical converter 150_{HP}, referred to as a high-pressure converter, designed to exchange power P_{HP} between the voltage bus 160 and the high-pressure body 103. For example, the electromechanical high-pressure converter 150_{HP} is designed, in a first power transfer direction, to draw mechanical power from the high-pressure body 103 so as to supply electrical power to the voltage bus 160. The electromechanical high-pressure converter 150_{HP} is also designed, for example, in a second power transfer direction, to draw electrical power from the voltage bus 160 so as to supply mechanical power to the high-pressure body 103. To exchange the power P_{HP}, a current I_{HP} is exchanged between the voltage bus 160 and the electromechanical high-pressure converter 150_{HP}.

For example, each electromechanical converter 150_{BP}, 150_{HP} comprises an electric machine coupled to the low-pressure body 104 or the high-pressure body 103, respectively, and an AC/DC converter designed to transfer electrical power between the voltage bus 160 and the electric machine. In this way, the electric machine may receive a mechanical torque to generate an alternating current which is rectified by the AC/DC converter to provide the bus voltage V_{DC}. The AC/DC converter may also convert the voltage V_{DC} to supply AC power to the electric machine so that the latter may provide a mechanical torque to inject power into the turbomachine 102.

The installation 100 also comprises, for each electromechanical converter 150_{BP}, 150_{HP}, a voltage control module 130_{BP}, 130_{HP} designed to control the bus voltage V_{DC} to a voltage setpoint V_{DC}+, the same for both modules 130_{BP}, 130_{HP}. Each voltage control module 130_{BP}, 130_{HP} is in particular designed to determine an exchange setpoint, noted G_{BP}*, G_{HP}*, of a physical quantity of the electromechanical converter 150_{BP}, 150_{HP} in question, so as to control the bus voltage V_{DC}, this physical quantity being linked to the exchanged power P_{BP}, P_{HP}. In fact, injecting electrical power into the voltage bus 160 tends to increase the bus voltage V_{DC}, while drawing electrical power from the voltage bus 160 tends to decrease the bus voltage V_{DC}. Thus, by adjusting the exchange setpoint G_{BP}*, G_{HP}*, it is possible to modify the exchanged power P_{BP}, P_{HP} so that the electromechanical converter 150_{BP}, 150_{HP} in question injects or withdraws more or less electrical power and therefore modifies the bus voltage V_{DC}.

The exchange setpoint G_{BP}*, G_{HP}* is, for example, a power setpoint to be exchanged P_{BP}*, P_{HP}* by the electromechanical converter 150_{BP}, 150_{HP} in question, as shown in brackets in FIG. 1.

Alternatively, the exchange setpoint G_{BP}*, G_{HP}* may be a setpoint for the current I_{BP}, I_{HP} between the electromechanical converter in question 150_{BP}, 150_{HP} and the voltage bus 160. When the setpoint V_{DC}* is constant, the bus voltage V_{DC}, which is controlled at this setpoint V_{DC}*, also remains substantially constant, so that the current I_{BP}, I_{HP} directly represents the exchanged power P_{BP}, P_{HP}.

Alternatively, the exchange setpoint G_{BP}*, G_{HP}* may be a setpoint for the torque of the electric machine.

The installation 100 also comprises two control modules 140_{BP}, 140_{HP} designed to control the electromechanical low-pressure converter 150_{BP}, respectively high-voltage converter 150_{HP}, so as to control the physical quantity to its exchange setpoint G_{BP}*, respectively G_{HP}*.

The installation 100 also comprises a power adjustment module 106 designed to adjust the power exchanged P_{BP}, P_{HP} by at least one of the electromechanical converters 150_{BP}, 150_{HP}, for example both as in the example shown. To this end, the power adjustment module 106 is designed to apply, for at least one of the electromechanical converters 150_{BP}, 150_{HP}, in the voltage control module 130_{BP}, 130_{HP}, a voltage correction δV_{BP}, δV_{HP}.

The voltage correction δV_{BP}, δV_{HP} is determined, for example, to allow an operating characteristic of the turbomachine 102 to be controlled to a setpoint Var*. For example and without limitation, the operating characteristic may comprise one or more of: the fuel inlet flow rate and/or the air inlet flow rate, a rotational speed of the low-pressure body 104, a rotational speed of the high-pressure body 103, an air inlet temperature and/or a fuel inlet temperature and/or an exhaust gas temperature exiting from the combustion chamber. For example, the voltage correction δV_{BP}, δV_{HP} is determined from a measurement Var of the operating characteristic and of the setpoint Var* of the operating characteristic.

The power adjustment module 106 is further configured, for example, to set a threshold value for the voltage corrections δV_{BP}, δV_{HP} so as to prevent, for example, a loss of stability in the voltage control. For example, and without limitation, said threshold value may be between 1% and 10% of the bus voltage V_{DC}.

To determine the voltage correction δV_{BP}, δV_{HP}, the power adjustment module 106 may for example firstly comprise a variation calculation module 108 designed to determine a power correction to be exchanged δP_{BP}, δP_{HP} by the electromechanical converter 150_{BP}, 150_{HP} in question, for example from a comparison between the measurement Var of the operating characteristic and the setpoint Var* of the operating characteristic. The power adjustment module 106 may further comprise a corrector 110_{BP}, 110_{HP} designed to determine the voltage correction δV_{BP}, δV_{HP} from the power correction to be exchanged δP_{BP}, δP_{HP}. The use of a corrector allows to avoid the problems associated with the use of a resistance value in the patent application JP 2014 131469 A discussed above.

In a non-limiting example, the turbomachine 102 may apply power during the take-off phase of the aircraft to accelerate the rotation of the high-pressure body 103. A minimum rotation speed N2ₘᵢₙ of the high-pressure body 103 may be defined for take-off to be effective. In this case, the variation calculation module 108 may determine a correction of non-zero (δP_{HP}≠0) power to be exchanged δP_{HP} for the HP electromechanical converter and a correction of power to be exchanged δP_{BP} which is zero (δP_{BP}=0) for the BP electromechanical converter. The corrector 110_{HP} associated with the HP electromechanical converter will then calculate the voltage correction δV_{HP} to be applied so that the HP electromechanical converter may inject power into the HP body of the turbomachine by drawing electrical power from the voltage bus 160 so as to supply mechanical power to the HP body. This will have the effect of increasing the speed of rotation so as to comply with the minimum rotational speed setpoint N2ₘᵢₙ.

Preferably, the corrector 110_{BP}, 110_{HP} has zero static error. For example, the corrector 110_{BP}, 110_{HP} is of the PI (proportional-integral) or PID (proportional-integral-derivative) type, for example with “anti-windup” control so as to prevent the degradation of performance or the loss of stability in the voltage or power control of the installation 100, which may be caused by the definition of the threshold value for the voltage corrections δV_{BP}, δV_{HP}.

Still referring to FIG. 1, the installation 100 may comprise independent local computers CL_{BP}, CL_{HP}, associated respectively with the low-pressure converter 150_{BP} and the high-pressure electromechanical converter 150_{HP}.

Each local computer CL_{BP}, CL_{HP} thus implements at least the voltage control module 130_{BP}, 130_{HP} and the control module 140_{BP}, 140_{HP} of the associated electromechanical converter 150_{BP}, 150_{HP}. This allows to use a reduced number of computers. Each local computer CL_{BP}, CL_{HP} may also implement the corrector 110_{BP}, 110_{HP} of the associated electromechanical converter 150_{BP}, 150_{HP}.

The installation 100 also comprises, for example, a central computer CC, independent of the local computers CL_{BP}, CL_{HP}, designed to implement the variation calculation module 108. The central computer CC may also implement one or both of the correctors 110_{HP}, 110_{BP}.

In the illustrative example shown in FIG. 1, the central computer CC implements the entire power adjustment module 106, i.e. the variation calculation module 108 and the two correctors 110_{HP}, 110_{BP}.

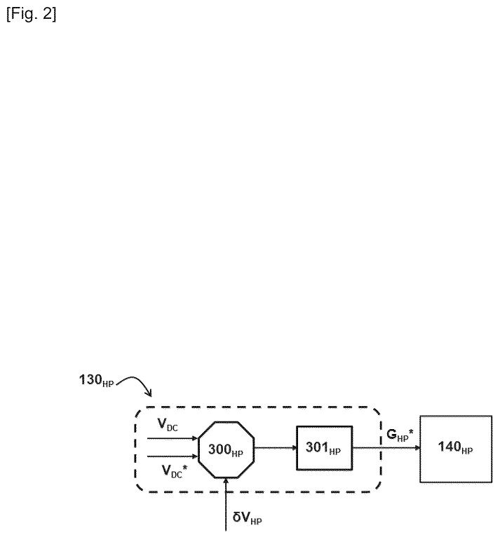

With reference to FIG. 2, the voltage control module 130_{HP} comprises, for example, a comparator 300_{HP}, designed to calculate a difference ΔV_{DC,HP} between the voltage setpoint V_{DC*} corrected by the voltage correction δV_{HP}, and the bus voltage V_{DC}: ΔV_{DC,HP}=V_{DC}*−δV_{HP}−V_{DC}.

Alternatively, the comparator 300_{HP} may be configured to calculate a difference ΔV²_{DC,HP} between the square of the voltage setpoint V_{DC*} corrected by the voltage correction δV_{HP}, and the square of the bus voltage V_{DC}: ΔV²_{DC,HP}=(V_{DC}*−δV_{HP})²−V²_{DC}.

The voltage control module 130_{HP} also comprises, for example, a corrector 301_{HP} designed to determine the exchange setpoint G_{HP}*, for example the setpoint of power P_{HP}* to be exchanged, from the difference ΔV_{DC,HP} or ΔV²_{DC,HP}. Preferably, the corrector has zero static error. For example, the corrector 301_{HP} is of type PI (proportional-integral) or PID (proportional-integral-derivative).

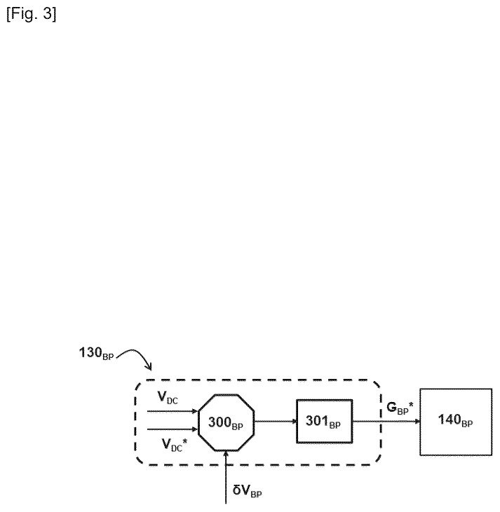

Similarly, with reference to FIG. 3, the voltage control module 130_{BP} comprises, for example, a comparator 300_{BP} and a corrector 301_{BP}.

The presence of zero static error correctors in the local computers CL_{BP}, CL_{HP} may lead to a discrepancy in power sharing, with one of the BP or HP electromechanical converters taking all the power. In order to control power sharing between the BP and HP electromechanical converters, the central computer CC may be designed to send voltage corrections δV_{BP}, δV_{HP} to the local computers CL_{BP}, CL_{HP} to balance the exchanged powers P_{BP}, P_{HP}.

Each voltage control module 130_{BP}, 130_{HP} may further be designed to implement voltage control at a voltage control sampling frequency, for example 10 KHz.

In order to stabilize the power exchanges of the installation 100, the power adjustment module 106 is preferably designed to update the voltage correction δV_{BP}, δV_{HP} at a frequency lower than the control frequency, preferably at a frequency ten times lower. This is because, in order not to disturb the voltage control and to give the voltage control time to control the voltage, it is preferable for the voltage correction δV_{BP}, δV_{HP} to be kept constant over several voltage control cycles. For example, the voltage correction may be updated at frequencies below 1 kHz. Thus, there is no need to provide for a fast communication (e.g. greater than 1 kHz) between the power adjustment module 106 and the voltage control modules 130_{HP}, 130_{BP}. With the previous implementation in the central computer CC and the local computer or computers CL_{BP}, CL_{HP}, it is therefore not necessary to provide a fast communication between the central computer CC and the local computer or computers CL_{BP}, CL_{HP}.

It will be appreciated that the installation 100 is thus designed to be able to operate with balancing (of power and/or voltage) active on one side only, which allows to ensure a redundancy in the event of loss of communication between the central computer CC and one of the local computers CL_{BP}, CL_{HP}.

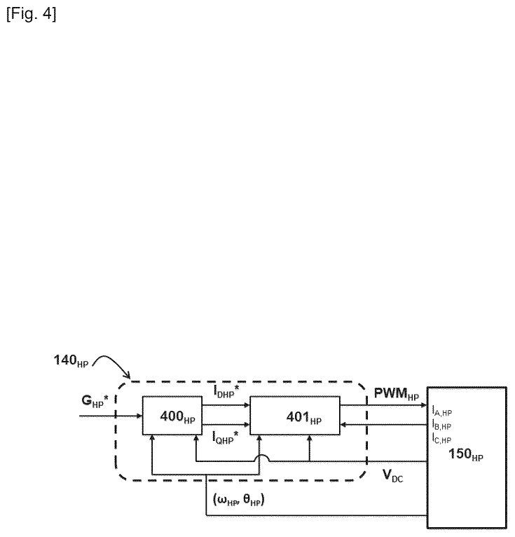

With reference to FIG. 4, the control module 140_{HP} comprises, for example, a block 400_{HP} designed to determine a setpoint for at least one current of the electromechanical converter 150_{HP}, this current or these currents defining the power exchanged. For example, phase currents I_{A,HP}, I_{B,HP}, I_{C,HP} for three phases of the electric machine, expressed in a rotating reference frame equipped with a direct axis and a quadrature axis by direct and quadrature currents. For example, the block 400_{HP} is designed to determine a direct current setpoint I_{D,HP}* and a quadrature current setpoint I_{Q,HP}*. This determination is made, for example, on the basis of an angular position θ_{HP} and a speed of rotation ω_{HP} of a rotor of the electric machine and of the bus voltage V_{DC}.

In particular, the angular position θ_{HP} and the speed of rotation ω_{HP} of the rotor of the electric machine allow to express the electrical quantities, such as the phase currents I_{A,HP}, I_{B,HP}, I_{C,HP}, in the rotating reference frame. The bus voltage V_{DC} may be used to modulate phase currents or determine the direct current setpoint I_{D,HP}* using a defluxing method.

The control module 140_{HP} also comprises, for example, a current control block 401_{HP} designed to supply commands to the high-pressure electromechanical converter 150_{HP} on the basis of the current setpoint or setpoints I_{DHP}*, I_{QHP}* and a measurement of this current or these currents, for example the phase currents I_{A,HP}, I_{B,HP}, I_{C,HP} for three phases A, B, and C. The controls are, for example, pulse width modulation controls PWM_{BP}, PWM_{HP}.

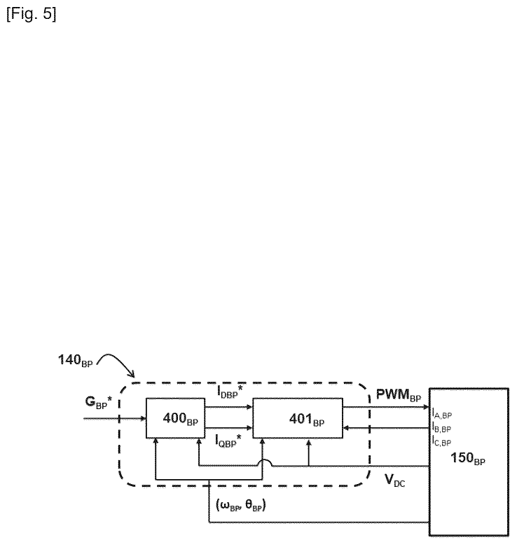

In a similar way, with reference to FIG. 5, the control module 140_{BP} comprises, for example, a block 400_{BP} designed to determine a setpoint for at least one current of the low-pressure electromechanical converter 150_{BP}, this current or these currents defining the power exchanged. For example, the phase currents of the electric machine, expressed as direct and quadrature currents. The block 400_{BP} is designed to determine a direct current setpoint I_{D,BP}* and a quadrature current setpoint I_{Q,BP}*. This determination is made, for example, from an angular position θ_{BP} and a speed of rotation ω_{BP} of a rotor of the electric machine and of the bus voltage V_{DC}.

The control module 140_{BP} also comprises, for example, a current control block 401_{BP} designed to supply commands to the low-pressure electromechanical converter 150_{BP} on the basis of the current setpoint or setpoints I_{D,BP}*, I_{Q,BP}* and a measurement of this current or these currents, for example the phase currents I_{A,BP}, I_{B,BP}, I_{C,BP} for three phases A, B, and C. The controls are, for example, pulse width modulation controls PWM_{BP}, PWM_{HP}.

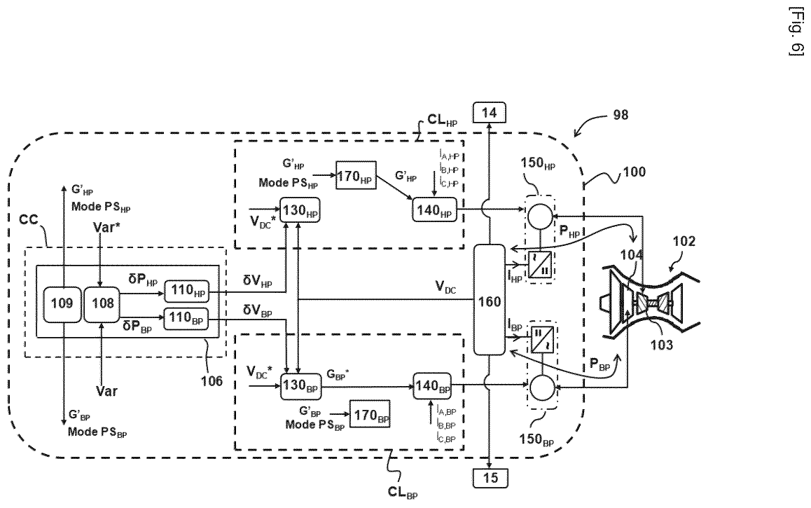

With reference to FIG. 6, the installation 100 may also comprise a setpoint determination module 109 designed to determine, for one or both of the electromechanical converters 150_{BP}, 150_{HP}, a so-called direct exchange setpoint G′_{BP}, G′_{HP}. The setpoint determination module 109 may, for example, be implemented by the central computer CC.

In this case, the installation 100 may also comprise, for each electromechanical converter 150_{BP}, 150_{HP}, a selection module 170_{BP}, 170_{HP} designed to directly receive the direct exchange setpoint G′_{BP}, G′_{HP} for the electromechanical converter 150_{BP}, 150_{HP} in question, for example from the central computer CC. The selection module 170_{BP}, 170_{HP} is also designed to supply the direct exchange setpoint G′_{BP}, G′_{HP} directly to the control module 140_{BP}, 140_{HP}, instead of the exchange setpoint G_{BP}*, G_{HP}* supplied by the voltage control module 130_{BP}, 130_{HP}. This is done selectively, for example on receipt of a Mode PS_{BP} or Mode PS_{HP} command, for example from the setpoint determination module 109. In this way, the power exchanged P_{BP}, P_{HP} by each electromechanical converter 150_{HP} is directly controlled according to the associated direct exchange setpoint G′_{BP}, G′_{HP}.

In the example shown in FIG. 6, only the selection module 170_{HP} is activated.

The direct supply of the direct exchange setpoint G′_{BP} or G′_{HP}, without having to calculate a voltage correction, allows to define the power exchanges in operating phases where the calculation of a voltage correction is not suitable, for example when you want the power exchange on one side to be fixed and the exchange on the other side to be arbitrary. In addition, the direct supply of the direct exchange setpoint G′_{BP} or G′_{HP} means that this setpoint may be applied more quickly, which is useful, for example, in the event of assistance.

On the side where the selection module 170_{HP}, 170_{BP} is activated, the bus voltage is no longer controlled. In this situation, the bus voltage V_{DC} is controlled on the other side.

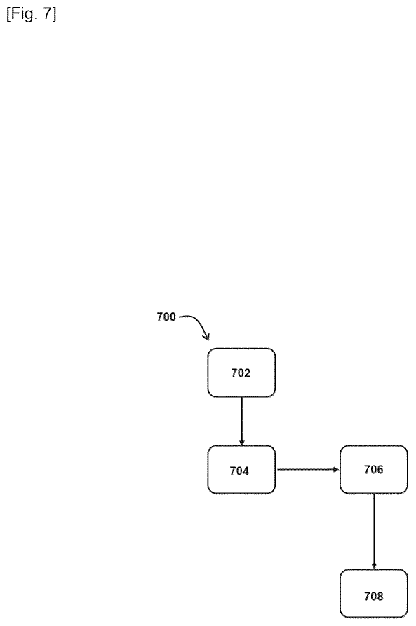

With reference to FIG. 7, an example of a power exchange method 700 according to the invention will now be described.

The method 700 comprises, for at least one of the electromechanical converters 150_{BP}, 150_{HP}, the following steps 702, 704.

In step 702, the voltage correction δV_{BP}, δV_{HP} is determined by the power adjustment module 106.

During step 704, the power adjustment module 106 applies, in the voltage control module 130_{BP}, 130_{HP} associated with the electromechanical converter 150_{BP}, 150_{HP} in question, the voltage correction δV_{BP}, δV_{HP} to the voltage setpoint V_{DC}*.

The method 700 also comprises, for each of the low-pressure electromechanical converter 150_{BP} and the high-pressure electromechanical converter 150_{HP}, the following steps 706, 708.

In step 706, the voltage control module 130_{HP}, 130_{BP} controls the bus voltage V_{DC} to the voltage setpoint V_{DC}* corrected, if necessary, by the voltage correction δV_{BP}, δV_{HP}, determining the exchange setpoint G_{BP}*, G_{HP}* for the electromechanical converter 150_{BP}, 150_{HP} in question.

During step 708, the control module 140_{HP}, 140_{BP} controls the electromechanical converter 150_{BP}, 150_{HP} in question, so that the electromechanical converter 150_{BP}, 150_{HP} in question complies with the exchange setpoint G_{BP}*, G_{HP}*.

In conclusion, it should be noted that the invention is not limited to the embodiments described above. In fact, it will appear to the person skilled in the art that various modifications may be made to the above-described embodiments, in the light of the teaching just disclosed.

In the foregoing detailed presentation of the invention, the terms used should not be interpreted as limiting the invention to the embodiments exposed in the present description, but should be interpreted to include all equivalents the anticipation of which is within the reach of the person skilled in the art by applying his general knowledge to the implementation of the teaching just disclosed.

1. An installation for exchanging power in an aircraft, comprising:
a voltage bus designed to present a bus voltage;
a low-pressure electromechanical converter designed to exchange power between the voltage bus and a low-pressure body of a turbomachine of the aircraft;
a high-pressure (HP) electromechanical converter designed to exchange power between the voltage bus and a high-pressure body of the turbomachine of the aircraft; and
for each electromechanical converter:
a voltage control module designed to receive a voltage setpoint (V_{DC}*), the same for both voltage control modules (130_{BP}, 130_{HP}), and to receive a voltage setpoint, the same for both voltage control modules, and to control the bus voltage by determining an exchange setpoint for the electromechanical converter in question, and
a control module designed to control the electromechanical converter in question, so that the electromechanical converter in question complies with the exchange setpoint;
wherein it further comprises a power adjustment module designed, for each of the electromechanical converters, for:
determining a voltage correction, and
applying, in the voltage control module associated with the electromechanical converter in question, the voltage correction to the voltage setpoint so that the voltage control module controls the bus voltage to the corrected voltage setpoint.

2. The power exchange installation according to claim 1, wherein the exchange setpoint is a power setpoint to be exchanged between the electromechanical converter in question and the voltage bus.

3. The power exchange installation according to claim 1, wherein the exchange setpoint is a setpoint for a current to be exchanged between the electromechanical converter in question and the voltage bus or, alternatively, the electromechanical converters each comprising an electric machine coupled to the associated body the exchange setpoint is a torque setpoint for the electric machine.

4. The power exchange installation according to claim 1, wherein the power adjustment module of the turbomachine comprises: a variation calculation module designed to determine a power correction to be exchanged by the electromechanical converter in question; and
a corrector designed to determine the voltage correction from the power correction to be exchanged.

5. The power exchange installation according to claim 4, wherein the corrector has zero static error.

6. The power exchange installation according to claim 1, wherein the voltage correction is determined in order to control an operating characteristic of the turbomachine to a setpoint.

7. The power exchange installation according to claim 6, wherein the voltage correction is determined from a measurement of the operating characteristic and of the setpoint of the operating characteristic.

8. The power exchange installation according to claim 1, wherein the power adjustment module furthermore comprises a setpoint determination module designed to determine a so-called direct exchange setpoint, and furthermore comprising, for the electromechanical converter in question, a selection module designed to, on command, receive the direct exchange setpoint and supply the latter to the control module of the electromechanical converter in question, instead of the exchange setpoint supplied by the voltage control module so that the electromechanical converter in question complies with the direct exchange setpoint.

9. The power exchange installation according to claim 1, comprising local computers, respectively low pressure and high pressure, independent of each other, and respectively coupled to the low pressure and high pressure electromechanical converters, each local computer implementing at least the control modules for controlling the voltage of the voltage bus and for controlling the electromechanical converter in question.

10. The power exchange installation according to claim 1, comprising a central computer implementing at least the power adjustment module.

11. The power exchange installation according to claim 9, wherein the central computer is independent of the local computers.

12. The power exchange installation according to claim 1, wherein the voltage control module is designed to implement the voltage control at a voltage control frequency, and wherein the power adjustment module is designed to update the voltage correction at a frequency lower than the control frequency, preferably at a frequency ten times lower.

13. A propulsion system for an aircraft comprising a turbomachine and an installation according to claim 1.

14. An aircraft comprising a propulsion system according to claim 13.

15. A method for exchanging power in an aircraft, wherein it comprises:
for each of a so-called low-pressure electromechanical converter and a so-called high-pressure electromechanical converter, the low-pressure electromechanical converter being designed to exchange power between a voltage bus designed to have a bus voltage and a low-pressure body of a turbomachine of the aircraft, the high-pressure electromechanical converter being designed to exchange power between the voltage bus and a high-pressure body of the turbomachine of the aircraft:
receiving a voltage setpoint, the same for both electromechanical converters,
controlling the bus voltage by determining an exchange setpoint for the electromechanical converter in question, and
controlling the electromechanical converter in question, so that the electromechanical converter in question complies with the exchange setpoint; and
for each of the electromechanical converters, an adjustment of power comprising:
determining a voltage correction, and
applying the voltage correction to the voltage setpoint so that the bus voltage is controlled at the corrected voltage setpoint.

16. A computer program that may be downloaded from a communication network and/or recorded on a non-transitory computer-readable medium, wherein it comprises instructions for executing the steps of a method for exchanging power in an aircraft according to claim 15, when said program is executed on a computer.
